(19) United States
(12) Patent Application Publication
(10) Pub. No.: US 2003/0223705 A1
(43) Pub. Date: Dec. 4, 2003

(54) Method for terminating an optical waveguide into an optical component

(76) Inventors: William F. Hill, Torquay (GB); Adrian P. Janssen, Exeter (GB); Luc Hunziker, Torquay (GB)

Correspondence Address: Mark D. Saraline, Esq., Renner, OTTO, Boisselle & Sklar, 1621 Euclid Avenue, 19th Floor, Cleveland, OH, 44115, US

(21) Appl. No.: 10/161,523

(22) Filed: Jun. 3, 2002

(51) Int. Cl. G02B 6/42; G02B 6/36

(52) U.S. Cl. 385/92; 385/93; 385/88; 385/139

(57) ABSTRACT

The invention is directed to a waveguide termination comprising a waveguide having an end and a window through which light can pass. The end of the waveguide has an elliptical face and the elliptical face reflects light between the waveguide and the window. Preferably the optical waveguide is an optical fibre.

### FIELD OF THE INVENTION

The present invention relates to an improved method for terminating an optical waveguide into an optical component.

### BACKGROUND TO THE INVENTION

Within an optical communications system there are many optical components. Optical components such as transmitters and receivers are used to convert signals from electrical signals to optical signals and vice versa. Optical multiplexors and demultiplexors are used to perform optical processing functions on the optical signals. Every optical component requires a way of bringing light either into or out of the component (or both) and in most cases this is done via an optical waveguide. This optical waveguide must be terminated into the optical component in order that light can enter or leave the waveguide. The optical waveguide is often an optical fibre.

FIGS. 1a and 1b show a schematic diagram of an optical receiver. FIG. 1a shows the receiver in plan view and FIG. 1b shows a cross section through the receiver. The receiver comprises a housing 102 which has a spout 104 with an open end 106, an optical fibre 108, and a substrate 110 on which the detector 112 is mounted. The housing has a number of legs or leads 114 which bring electrical connections out of the housing and also provide a means for mounting the component on a printed circuit board (PCB). The optical fibre 108 is terminated into the receiver by entering the housing 102 through the open end of the spout 106. The end of the optical fibre 116 is located close to the detector 112 such that light travelling along the optical fibre 108 shines on to the active region of the detector 112. The active region of a detector is the area which is designed to receive light and convert the energy into an electrical signal.

In order that most of the light from the optical fibre falls on to the active region of the detector it is necessary to align the fibre accurately with the active region of the detector (for example to within 2-5 μm) and to fix it in position in such a way that it does not move over life. The optical fibre is therefore fixed to the substrate 110 onto which the detector 112 is mounted and also fixed into the spout 104. The fixing to the substrate keeps the fibre and the detector aligned and the fixing in the spout provides a strong fixing which means that the fibre does not pull out of the housing when it is handled. As a result of the spout on the housing, which is required to ensure a long length over which the fibre is fixed, the resultant component is much bigger than the detector 112.

As optical communications systems become more complex, the number of optical components they include increases. However, the available space does not increase correspondingly and so component size is increasingly a problem.

There are currently a large number of different optical fibre connectors available. Each receiver purchased will require the customer's specified choice of connector and length of optical fibre. In the manufacture of a receiver as shown in figures 1a and 1b, it is necessary to terminate the optical fibre into the receiver in order to be able to optically test the device. This means that before the device is tested it is necessary to decide who the final customer for the product will be. This leads to large inventories of finished goods being required in order to meet the expected order to delivery times, and it also leads to high manufacturing costs as devices cannot be effectively screened prior to the lengthy (and often manual) process of fibre termination.

In the competitive communications market, component prices are continually being driven down. High manufacturing costs, especially when processes are done manually, are increasingly a problem.

### OBJECT TO THE INVENTION

The invention seeks to provide an improved method for terminating an optical waveguide into an optical component which mitigates at least one of the problems of known methods.

### SUMMARY OF THE INVENTION

The invention is directed to a waveguide termination comprising: a waveguide having an end, said end having an elliptical face; and a window through which light can pass, wherein the elliptical face reflects light between the waveguide and the window.

Preferably, the waveguide is an optical fibre.

Preferably, the elliptical face has a reflective coating. This increases the proportion of light which is reflected and therefore reduces the loss of the termination.

The invention is also directed to an optical component comprising: a waveguide having an end, said end having an elliptical face; and a window through which light can pass, wherein the elliptical face reflects light between the waveguide and the window.

Preferably, the waveguide is an optical fibre.

Preferably, the optical component comprises a housing, said housing having a face, wherein said window is in said face of the housing.

The window may be formed in a number of ways, including, but not limited to, an opening in the face of the housing, a piece of an optically transparent material and a lens.

It may be preferable that the optical component further comprises a lens mounted within the housing. The lens may be a focussing lens and may be fixed within the housing to the window.

Preferably, the waveguide is fixed to the face of the housing.

Preferably, the optical component further comprises a cover, wherein the cover is fixed to said face of the housing such that it protects the end of the waveguide.

The invention is further directed to an optical receiver comprising: a waveguide having an end, said end having an elliptical face; a housing having a window; and a detector, said detector being fixed within the housing, wherein the elliptical face is capable of reflecting light from the waveguide, through the window and onto the detector.

It may be preferable that the optical receiver further comprises a lens mounted within the housing, said lens being capable of focusing light from the optical waveguide on to the detector.

The invention is also directed to an optical transceiver including a receiver as described above.

The invention is further directed to a network element and an optical system including an optical component as described above.

The invention is also directed to a method of terminating a waveguide comprising the steps of: taking a waveguide having an end, said end having an elliptical face; taking a window; aligning the waveguide and the window such that the elliptical face reflects light between the waveguide and the window.

Preferably, the waveguide is an optical fibre.

Preferably, window is formed in a face of a housing.

Preferably, the method of terminating a waveguide further comprises the step of fixing the waveguide to said face of the housing.

The window may be an opening in the face of the housing.

Preferably, the elliptical face has a reflective coating.

Preferably, the method of terminating a waveguide further comprises the steps of: taking a cover; and mounting said cover to said face of the housing such that it protects the elliptical face.

The invention is also directed to a method of manufacturing an optical receiver comprising the steps of: taking a housing having a face and a detector, said face having a window and said detector being mounted in the housing; taking an optical waveguide, said waveguide having an end, said end having an elliptical face; and mounting the optical waveguide on the face of the housing such that the elliptical face is capable of reflecting light from the optical waveguide, through the window and onto the detector.

Preferably, the optical waveguide is an optical fibre.

It may be preferred that the housing further comprises a lens mounted within the housing, said lens being capable of focussing light from said optical waveguide on to said detector.

Preferably, the method of manufacturing an optical receiver further comprises the steps of: taking a cover; and mounting said cover to said face of the housing such that it protects the elliptical face.

The invention is also directed to a waveguide termination comprising: a waveguide having a bevelled end; and a window through which light can pass, wherein the bevelled end reflects light between the waveguide and the window.

An advantage of the present invention is that it leads to a compact optical component. The long spout which exists on conventional optical components is not required and yet the strength of the fibre-housing joint is not compromised. Additionally, the optical fibre still exits the optical component parallel to the PCB onto which it is mounted. This is important because it allows the PCBs to be placed close together, which again increases the amount of optical and electrical functionality which can be included within a given volume.

Another advantage of the present invention is that it results in a simplified housing. A large proportion of the cost of an optical component is the cost of the housing itself due to the complex machining, moulding or other processes that are required to manufacture the housing. A simpler housing structure results in significant cost reduction.

A further advantage of the present invention is that it provides a simplified manufacturing route. The housing can be fabricated separately and if hermeticity is required, the need to form a hermetic seal round an optical fibre is removed.

Another advantage of the present invention is that by using a window in the housing, it is possible to optically test the component before attaching the fibre. Additionally, by delaying the attachment of the optical fibre to the housing to the end of the manufacturing process it permits improved inventory management as components are not allocated to a specific customer until a late stage. This also makes the method suitable for automated manufacture because handling of parts with fibres attached is hard to automate.

An advantage of the cover is that it provides protection for the end of the waveguide when the component is handled. The cover also keeps debris from collecting on the end of the optical waveguide and the window.

If the component is an optical transmitter, the cover also provides the additional advantage of being a safety feature by preventing stray light from exiting the housing other than via the optical waveguide.

The preferred features may be combined as appropriate, as would be apparent to a skilled person, and may be combined with any of the aspects of the invention.

### BRIEF DESCRIPTION OF THE DRAWINGS

Reference will now be made, by way of example, to the accompanying drawings, in which:

FIG. 1a shows a schematic diagram of a Prior Art optical receiver in plan view;

FIG. 1b shows a schematic diagram of a Prior Art optical receiver in cross-section;

FIG. 2a shows an optical receiver according to a first example of this invention;

FIG. 2b shows an enlarged view of a section of FIG. 2a;

FIG. 2c shows an optical receiver according to a first example of this invention.

FIG. 3 is a diagram showing the steps of a method of manufacturing an optical received according to a second example of this invention;

FIG. 4 shows a planar waveguide component according to a third example of this invention; and

FIG. 5 shows an optical transmitter according to a fourth example of this invention.

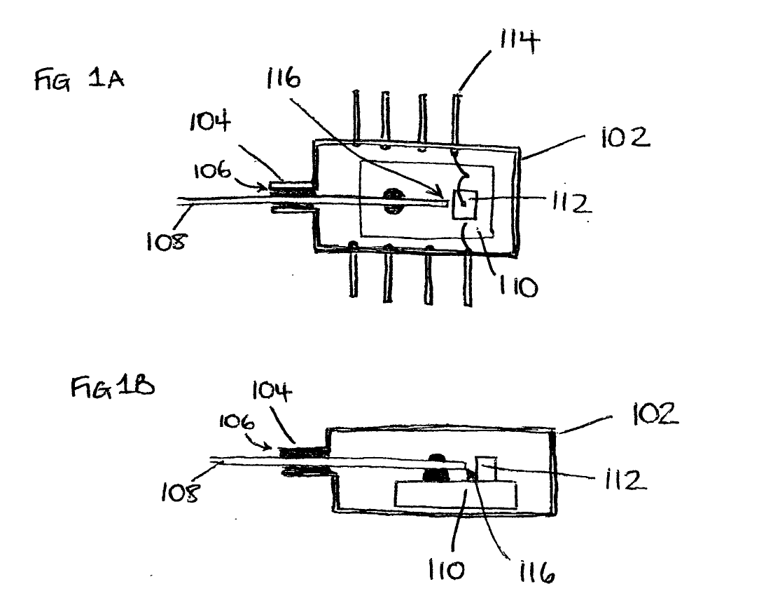

### DETAILED DESCRIPTION OF INVENTION

Embodiments of the present invention are described below by way of example only. These examples represent the best ways of putting the invention into practice that are currently known to the Applicant although they are not the only ways in which this could be achieved.

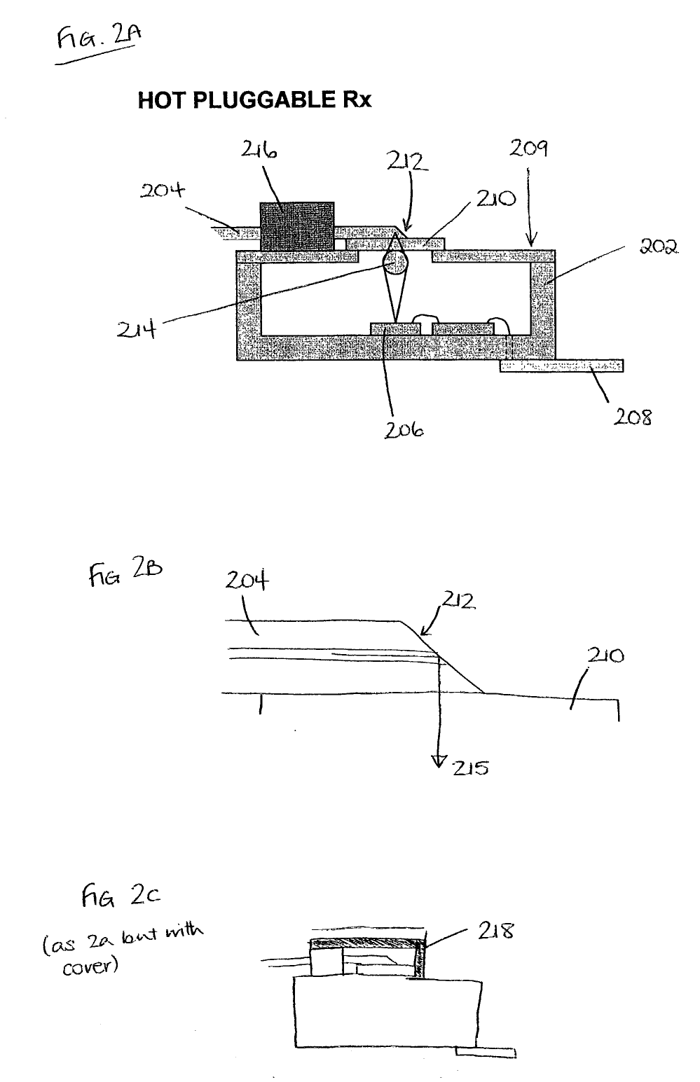

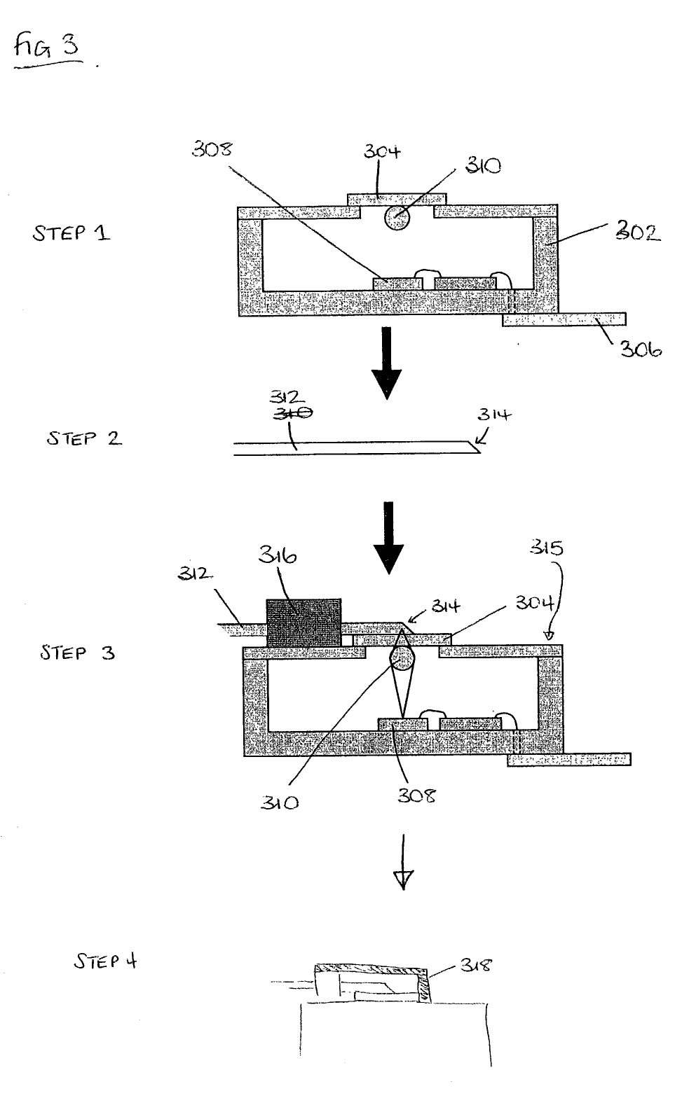

Referring to FIGS. 2a-c there is shown a first example of the present invention. FIGS. 2a-c show an optical receiver component. FIG. 2a shows a package or housing 202, an optical fibre 204 and a detector 206. The housing has metal leads 208 which bring electrical connections out of the housing and a face 209 which contains a window 210. The optical fibre 204 has an end 212 which is bevelled and therefore has an elliptical face. The detector 206 is mounted inside the housing 202. The optical fibre 204 is fixed to a face of the housing 209 such that light travelling along the optical fibre 204 is reflected by the elliptical face 212 and passes through the window 210. The light is then focussed by a lens 214 on to the detector 206.

The housing 202 may be made from many materials including, but not limited to, metals such as kovar or aluminium, ceramics and plastics and it may be fabricated by processes such as machining or moulding. In some applications, it may be necessary to hermetically seal the housing to prevent moisture from entering the housing. Moisture can be detrimental to the performance of some components because it accelerates ageing mechanisms and because in some environments condensation can form on any exposed optical surfaces, e.g. on the end of the optical fibre.

The optical fibre 204 may be a single mode or a multimode fibre. Alternatively, if the detector 206 is an array of detectors, the optical fibre 204 may be an optical fibre ribbon containing a plurality of optical fibres.

The bevelled end and hence the elliptical face of the optical fibre 212 may be formed by a number of techniques including, but not limited to, angled cleaving, polishing and laser cleaving. Alternatively a small angled block or mirror may be fixed to the end of the optical fibre 204.

The elliptical face 212 of the optical fibre may be covered in a reflective coating to increase the amount of light which is reflected in to the housing. Suitable reflective coatings include, but are not limited to metal or dielectric layers. Suitable coating techniques include, but are not limited to, sputtering and evaporation.

FIGS. 2a and 2b show the elliptical face 212 being at approximately 450 to the longitudinal axis of the fibre. This results in the light being turned through 900, as is shown in FIG. 2b, where the direction of travel of the light is shown by the arrow 215. However, for some configurations, it may be beneficial to use other angles and other relative positions of components.

The optical fibre 204 is fixed to the face of the housing 209 by means of a glass block 216. The glass block 216 has a hole through it which has a diameter which is just larger than the outer diameter of the optical fibre 204. The optical fibre is passed through the hole and fixed into the glass block 216. The glass block is then fixed on to the face of the housing 209. Additionally, the optical fibre may also be fixed to the window. Suitable fixing techniques include, but are not limited to, epoxies, solders, and low melting point glasses. FIG. 2a shows the optical fibre being fixed to the top face of the housing, however, the fibre could be fixed to any face of the housing which has a window. The fixing technique using the glass block 216 with a hole through it, described above, is only one example of a fixing technique.

In FIGS. 2a and 2b the window 210 is formed by an opening in the housing which is covered by a plate made from a substantially transparent material such as silica. This window could, however, be formed in many ways including, but not limited to, an opening in the housing, a housing fabricated from a transparent material, a housing with a lens mounted within the face and a housing with a substantially transparent face or lid.

In FIG. 2a a lens 214 is mounted within the package to focus the light on to the detector 214. This lens may not be necessary in some configurations, for example if the active area on the detector is large. Alternatively, for some optical configurations it may be beneficial to use a diverging lens.

It may be advantageous to attach a cover 218 over the elliptical face of the optical fibre 212, as shown in FIG. 2c. This cover protects the end of the optical fibre from damage when the component is handled.

Referring to FIG. 3 there is shown a second example of the present invention. FIG. 3 shows a method of manufacturing an optical receiver. The first step is to take a housing 302 which has a window 304 on one face. This housing has metal legs or leads 306 which bring electrical connections out of the housing and the housing contains a detector 308. The detector has an active area which is designed to receive light and convert that energy in to an electrical signal. The detector 308 is fixed within the housing 302. The housing also contains a lens 310 which is fixed to the window and arranged such that it is capable of focussing light which enters the housing on to the active area of the detector.

Suitable alternatives for the housing 302 include those detailed above.

The window 304 is formed by an opening in the housing which is covered by a plate made from a substantially transparent material such as silica, and suitable alternatives include those listed above.

The detector 308 is shown as being fixed to the base of the inside of the housing 302. This is by way of example only.

The second step is to take an optical fibre 312 which has an elliptical face 314. Suitable methods for forming an elliptical face include those which have been listed above.

The elliptical face 314 of the optical fibre may be covered in a reflective coating to increase the amount of light which is reflected in to the housing. Suitable materials and coating techniques include those listed above.

The third step is to mount the optical fibre 312 on the face of the housing. The fibre is positioned and fixed such that light from the optical fibre is reflected by the elliptical face 314, passes through the window 304 and is focussed by the lens 310 on to the active area of the detector 308.

The optical fibre 312 is fixed to the face of the housing 315 by means of a glass block 316. The glass block 316 has a hole through it which has a diameter which is just larger than the outer diameter of the optical fibre 312. The optical fibre is passed through the hole and fixed into the glass block 316. The glass block is then fixed on to the face of the housing 315. Additionally, the optical fibre may also be fixed to the window 304.

Suitable fixing techniques include those listed above. FIG. 3 shows the optical fibre being fixed to the top face of the housing, however, the fibre could be fixed to any face of the housing which has a window. The fixing technique using the glass block 316 with a hole through it, described above, is only one example of a suitable fixing technique.

For some applications, it may be advantageous to carry out a fourth step. The fourth step is to attach a cover 318 over the elliptical face of the optical fibre 314. This cover protects the end of the optical fibre from damage when the component is handled.

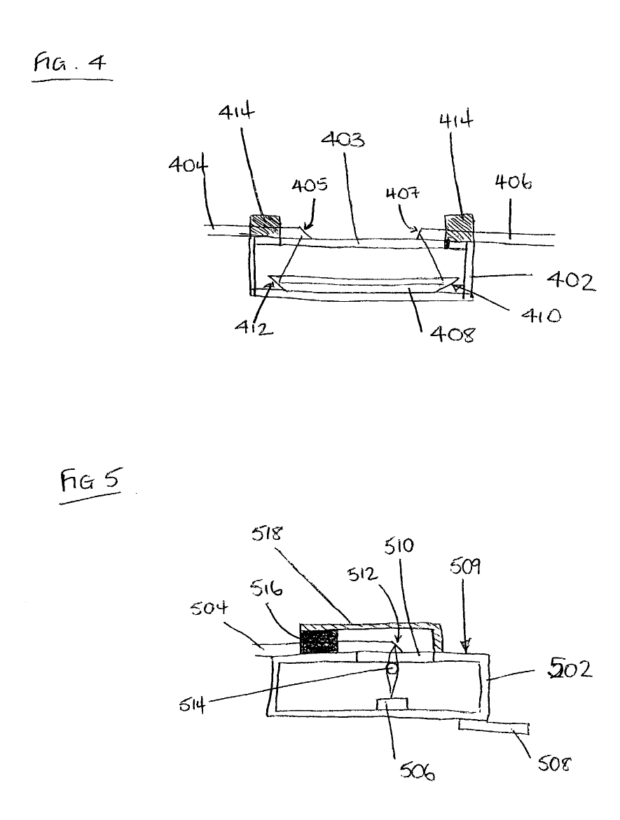

Referring to FIG. 4 there is shown a third example of the present invention. FIG. 4 shows a planar waveguide (PWG) component such as a multiplexor/demultiplexor or a variable optical attenuator. FIG. 4 shows a package or housing 402 and two optical waveguides (or sets of optical waveguides) 404, 406. One face of the housing 402 has a window 403. The optical waveguides 404, 406 have elliptical faces 405, 407. The housing 402 contains a PWG chip 408 which has two angled faces 410, 412.

The PWG chip has a network of waveguides which extend from one angled face 410 to the other angled face 412.

The optical waveguides 404, 406 are fixed to a face of the housing such light is capable of being coupled from one optical waveguide (or set of optical waveguides) into the PWG chip by being reflected by the elliptical face of that waveguide, passing through the window and being reflected by an angled face of the PWG chip into said chip. They are further arranged such that light is capable of being coupled from the PWG chip into one optical waveguide (or set of optical waveguides) by being reflected by the angled face of the PWG chip, passing through the window and being reflected by the elliptical face of the optical waveguide into the core of that waveguide.

Suitable configurations for the window 403 include those described above. Where more than one optical waveguide or optical fibre is being terminated into an optical component, the housing may have more than one window and these windows may be on the same or different faces of the housing.

The optical waveguides 404, 406 may be single optical fibres or optical fibre ribbons containing a plurality of optical fibres. Techniques for forming the elliptical faces have been described earlier.

FIG. 4 shows a PWG chip with two angled faces 410, 412. Alternatively, the PWG chip may be designed such that the input and output waveguides are located on the same side of the chip. In this case, only one angled face 410 is required and only one set of waveguides 404 is required to couple to the chip.

The PWG chip 408 may be made from any suitable technology including, but not limited to, silica on silicon, silicon on silica and indium phosphide technologies.

There are a number of techniques for forming the angled faces 410, 412 on the PWG chip 408 including, but not limited to, dicing using a diamond saw, laser cutting and polishing. The angled faces may also have a reflective coating on them, such as a metal or dielectric layer, as discussed earlier with relation to the elliptical face.

The optical waveguides 404, 406 are fixed to the face of the housing by means of a glass blocks 414 as described in previous examples. Additionally, the optical waveguides may also be fixed to the window 403.

Suitable alternatives include those described in previous examples.

Referring to FIG. 5 there is shown a fourth example of the present invention. FIG. 5 shows an optical transmitter component. FIG. 5 shows a housing 502, an optical fibre 504 and a laser 506. The housing has metal legs or leads 508 which bring electrical connections out of the housing and a face 509 which contains a window 510. The optical fibre 504 has an end which has an elliptical face 512. The laser 506 is mounted inside the housing 502. The optical fibre 504 is fixed to a face of the housing 509 such that light emitted by the laser 506 passes through the window 510, is reflected by the elliptical face 512 and is coupled into the optical fibre 504. Depending on the divergence of the beam of light which is emitted by the laser 506, it may be necessary to include a lens 514 to shape the beam of light (for example to focus it). A cover 518 is fixed over the elliptical face 512.

The laser 506 shown in FIG. 5 is a vertical cavity surface emitting laser (VCSEL). This invention is not limited to optical transmitters containing VCSELs and could also be used for other types of laser such as an edge-emitting device.

Suitable techniques for forming the elliptical face 512 are as described in previous examples.

The elliptical face 512 of the optical fibre may be covered in a reflective coating to increase the amount of light which is reflected as described in previous examples.

FIG. 5 shows the elliptical face 512 being at approximately 45° to the longitudinal axis of the fibre. This results in the light being turned through 90°. However, for some configurations, it may be beneficial to use other angles and other relative positions of components (this may lead to an even more compact component).

The optical fibre 504 is fixed to the face of the housing 509 by means of a glass block 516 as described in previous examples.

In FIG. 5 the window 510 can be formed in a number of ways including, but not limited to, those described in previous examples.

The cover 518 is preferably not transparent to the wavelength of light emitted from the laser 506. The cover therefore provides both a safety feature, which prevents any stray light from the laser being emitted from the package other than down the optical fibre 504, and a protective cover, which prevents the end of the optical fibre from damage when the component is handled.

Any range or device value given herein may be extended or altered without losing the effect sought, as will be apparent to the skilled person for an understanding of the teachings herein.

1. A waveguide termination comprising:
a waveguide having an end, said end having an elliptical face; and
a window through which light can pass,
wherein the elliptical face reflects light between the waveguide and the window.

2. A waveguide termination as claimed in claim 1, wherein the waveguide is an optical fibre.

3. A waveguide termination as claimed in claim 1, wherein the elliptical face has a reflective coating.

4. An optical component comprising:
a waveguide having an end, said end having an elliptical face; and
a window through which light can pass,
wherein the elliptical face reflects light between the waveguide and the window.

5. An optical component as claimed in claim 4, wherein the waveguide is an optical fibre.

6. An optical component as claimed in claim 4, further comprising a housing, said housing having a face, wherein said window is in said face of the housing.

7. An optical component as claimed in claim 6, wherein the window is an opening in the face of the housing.

8. An optical component as claimed in claim 4, wherein said window is made from an optically transparent material.

9. An optical component as claimed in claim 4, wherein said window comprises a lens.

10. An optical component as claimed in claim 6, further comprising a lens mounted within the housing.

11. An optical component as claimed in claim 10, wherein the lens is a focussing lens.

12. An optical component as claimed in claim 10, wherein the lens is fixed within the housing to the window.

13. An optical component as claimed in claim 6, wherein the waveguide is fixed to the face of the housing.

14. An optical component as claimed in claim 13 further comprising a cover, wherein the cover is fixed to said face of the housing such that it protects the end of the waveguide.

15. An optical receiver comprising:
a waveguide having an end, said end having an elliptical face;
a housing having a window; and
a detector, said detector being fixed within the housing,
wherein the elliptical face is capable of reflecting light from the waveguide, through the window and onto the detector.

16. An optical receiver as claimed in claim 15, further comprising a lens mounted within the housing, said lens being capable of focusing light from the optical waveguide on to the detector.

17. An optical transceiver including a receiver as claimed in claim 15.

18. A network element including an optical component as claimed in claim 4.

19. An optical system including an optical component as claimed in claim 4.

20. A method of terminating a waveguide comprising the steps of:
taking a waveguide having an end, said end having an elliptical face;
taking a window;
aligning the waveguide and the window such that the elliptical face reflects light between the waveguide and the window.

21. A method of terminating a waveguide as claimed in claim 20, wherein the waveguide is an optical fibre.

22. A method of terminating a waveguide as claimed in claim 20, wherein said window is in a face of a housing.

23. A method of terminating a waveguide as claimed in claim 22, further comprising the step of fixing the waveguide to said face of the housing.

24. A method of terminating a waveguide as claimed in claim 22, wherein said window is an opening in the face of the housing.

25. A method of terminating a waveguide as claimed in claim 20, wherein the elliptical face has a reflective coating.

26. A method of terminating a waveguide as claimed in claim 23 further comprising the steps of:
taking a cover; and
mounting said cover to said face of the housing such that it protects the elliptical face.

27. A method of manufacturing an optical receiver comprising the steps of:
taking a housing having a face and a detector, said face having a window and said detector being mounted in the housing;
taking an optical waveguide, said waveguide having an end, said end having an elliptical face; and
mounting the optical waveguide on the face of the housing such that the elliptical face is capable of reflecting light from the optical waveguide, through the window and onto the detector.

28. A method of manufacturing an optical receiver as claimed in claim 27, wherein the optical waveguide is an optical fibre.

29. A method of manufacturing an optical receiver as claimed in claim 27, wherein the housing further comprises a lens mounted within the housing, said lens being capable of focussing light from said optical waveguide on to said detector.

30. A method of manufacturing an optical receiver as claimed in claim 27 further comprising the steps of:
taking a cover; and
mounting said cover to said face of the housing such that it protects the elliptical face.

31. A waveguide termination comprising:
a waveguide having a bevelled end; and
a window through which light can pass,
wherein the bevelled end reflects light between the waveguide and the window.
